(19) United States
(12) Patent Application Publication
(10) Pub. No.: US 2003/0138278 A1
(43) Pub. Date: Jul. 24, 2003

(54) Moveable keyboard

(76) Inventors: Ronald Green, Collingwood (CA); Len Green, Collingwood (CA)

Correspondence Address: Elias C. Borges, 1 Eva Road - Suite 406, Toronto, ON, M9C 4Z5, CA

(21) Appl. No.: 10/047,894

(22) Filed: Jan. 23, 2002

(51) Int. Cl. B41J 5/12

(52) U.S. Cl. 400/472

(57) ABSTRACT

An ergonomic keyboard device is disclosed which reduces the amount of strain and fatigue in the user. The device consists of a keyboard mounted in a housing, the keyboard having a forward edge, a back edge and a longitudinal axis. The keyboard is moveably mounted to the housing such that the keyboard is moveable in a first direction whereby the keyboard moves forward and back. The keyboard is also mounted to the housing in such a way that it can pivot about its longitudinal axis. The keyboard device also has a mechanism for continuously oscillating the keyboard in both the back and forth motion and in the pivotal motion simultaneously.

### FIELD OF THE INVENTION

The invention relates generally to moveable keyboards.

### BACKGROUND OF THE INVENTION

People who spend extended periods of time at a computer keyboard, such as secretaries or data entry technicians, often develop fatigue and discomfort in the hands and forearms. The fatigue and discomfort is generally a result of holding the hands and wrists in an unnatural and fixed position for an extended period of time. In severe cases, prolonged use of computer keyboards can lead to a repetitive strain injury such as carpal tunnel syndrome. Ergonomic keyboards have been introduced to minimize the pain and discomfort which accompanies prolonged keyboard use. Many of these ergonomic keyboards involve support members for supporting the users hands and wrists while typing. Other ergonomic keyboards use a keyboard layout which better suites the users hands and posture. Unfortunately, these static ergonomic designs do not alleviate one of the main causes of hand strain, namely the static positioning of the hands for an extended period of time.

In an attempt to overcome the short comings of previous ergonomic keyboard designs, moving keyboards have recently been disclosed. Two such devices are disclosed in U.S. Pat. No. 5,951,179 to Zarek and U.S. Pat. No. 5,564,844 to Patterson, Jr. et al.. The Patterson device is a keyboard which tilts up and down about a fixed access at the front of the keyboard. The keyboard is operatively coupled to a cam mechanism which is powered by an electric motor which forces the keyboard to continuously tilt up and down while the user types. As a result of the continuous up and down tilting motion of the keyboard, the user's hands are kept in motion, and as a result, the user is less likely to develop carpal tunnel syndrome. The Zarek Patent shows a somewhat similar device where the keyboard tilts up and down along a central access. The device is provided with a driving mechanism for driving the tilting mechanism which causes the keyboard to tilt up and down. Like the Patterson device, the Zarek keyboard device forces the user to continuously move the position of his/her hands while typing.

While these moveable keyboard designs do increase the amount of lubrication in the hand and wristjoints, both of these keyboards are capable of generating only a limited range of movement. As a result, prolonged use of these devices may still result in pain or discomfort. There is still a need for ergonomic keyboard designs which are simply to construct and which are more effective in eliminating the strain and fatigue associated with long hours of keyboard use.

### SUMMARY OF THE INVENTION

The invention is an ergonomic keyboard device which reduces the amount of strain and fatigue in the user. The device consists of a keyboard mounted in a housing, the keyboard having a forward edge, a back edge and a longitudinal axis. The keyboard is moveably mounted to the housing such as the keyboard is moveable in a first direction whereby the keyboard moves forward and back. The keyboard is also mounted to the housing in such a way that it can pivot about its longitudinal axis. The keyboard device also has a mechanism for continuously oscillating the keyboard in both a back and forth motion and in the pivotal motion simultaneously.

Other objects and advantages of the invention will be evident from the following detailed description when read in conjunction with the accompanying drawings which illustrate the invention.

### BRIEF DESCRIPTION OF THE DRAWINGS

FIG. 1: Is a perspective view of the continuous motion keyboard apparatus made in accordance with the present invention.

FIG. 2: Is a top view of the keyboard apparatus with a portion of the keyboard housing support cut away.

FIG. 3: Is a cross sectional view of the moveable keyboard device showing the keyboard support in its first position.

FIG. 4: Is a cross sectional view of the device showing the keyboard support in its second position.

FIG. 5: Is a cross sectional view of the present invention showing the keyboard support in its third position.

FIG. 6: Is a cross sectional view showing the keyboard support in its fourth position.

### DETAILED DESCRIPTION OF THE INVENTION

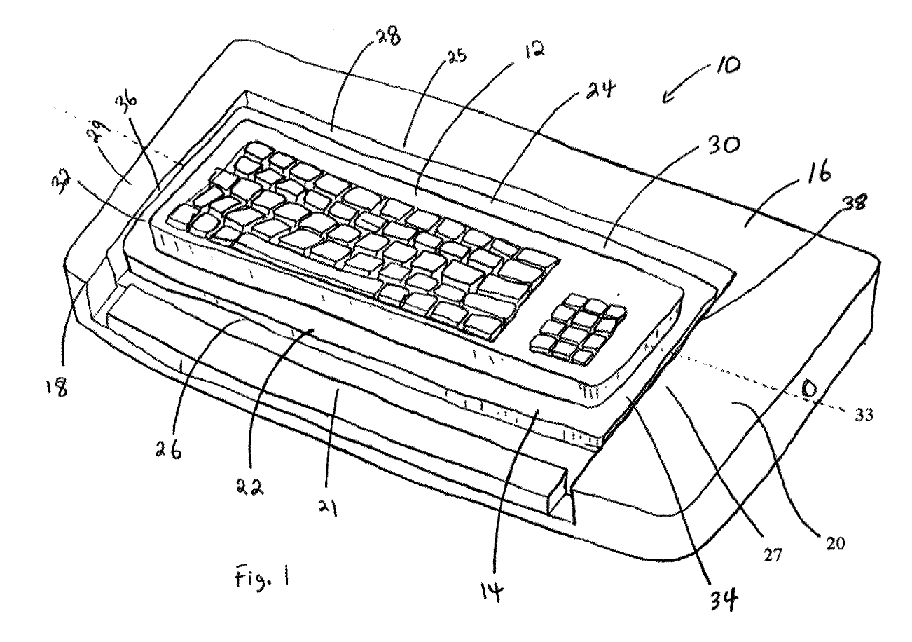

Referring firstly to FIG. 1, a keyboard made in accordance with the present invention is shown generally as item 10 and comprises keyboard 12, which rests on moveable member 14, which is contained within housing 16. Housing 16 is provided with central cavity 18 which is dimensioned to receive moveable member 14. Moveable member 14 has forward edge 22, back edge 24, side edges 32 and 34 and longitudinal axis 33. Housing 16 has central cavity 18 which is defined by forward edge 21, rear edge 25 and side edges 27 and 29. Edge 21 of housing 16 and edge 22 of moveable member 14 are separated by gap 26 which is a continuation of cavity 18. Similarity, edges 25 and 24 are separated by gap 28. Gaps 26 and 28 are sufficiently wide to permit moveable member 14 to be moved backward and forward in a first direction and to be pivoted up and down in a second direction relative to axis 33. Moveable member 14 is moved forward and back and also tilted up and down by an oscillating motion mechanism (not shown) which is housed in compartment 20 of housing 16. Moveable member 14 is provided with top surface 30 which is configured to receive keyboard 12 thereon. Preferably top surface 30 is adapted to prevent keyboard 12 from sliding off of moveable member 14.

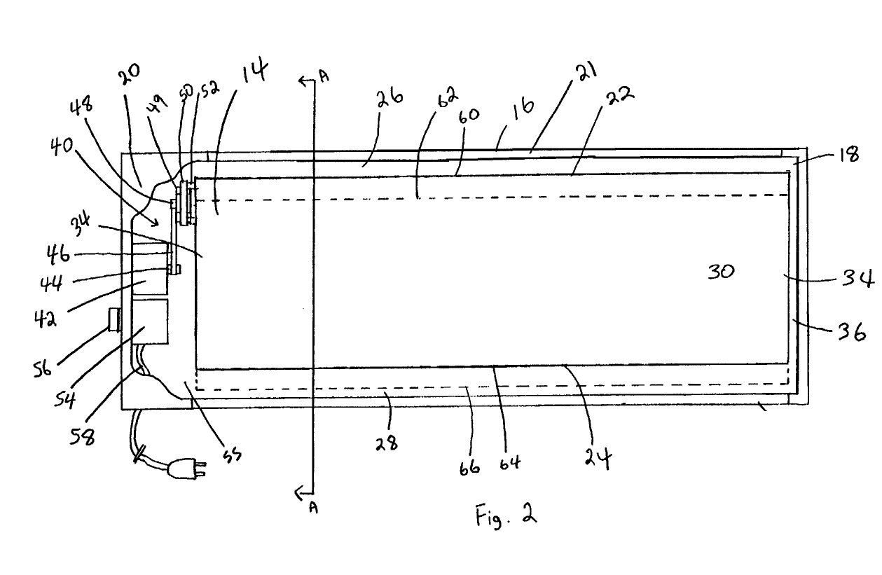

Referring now to FIG. 2, oscillating motion mechanism 40 is adapted to move moveable member 14 forward and backward between a first position wherein forward edge 22 is positioned close to forward edge 21 of housing 16 as indicated by dashed line 60, and a second position where forward edge 22 is position further away from forward edge 21 as indicated by dashed line 62. Mechanism 40 is also adapted to pivot moveable member 14 about its longitudinal axis 33.

Wave motion mechanism 40 comprises an electric motor 42 having pulley 44 which is operatively coupled to drive member 50 via pulley 44 and belt 46. Drive member 50 is rotatably mounted to mounting 49 which is in turn mounted to floor 55 of housing 16. Member 50 is mechanically coupled to edge 34 of moveable member 14 towards front edge 22 via strut 52. Electric motor 42 is controlled by power modulator 54 which in turn is operatively coupled to electric cord 58 and speed selector dial 56. When electric cord 58 is supplied with power, modulator 54 supplies electric energy to electric motor 42 which in turn causes member 50 to rotate. The user can adjust the speed of electric motor 42 by turning dial 56.

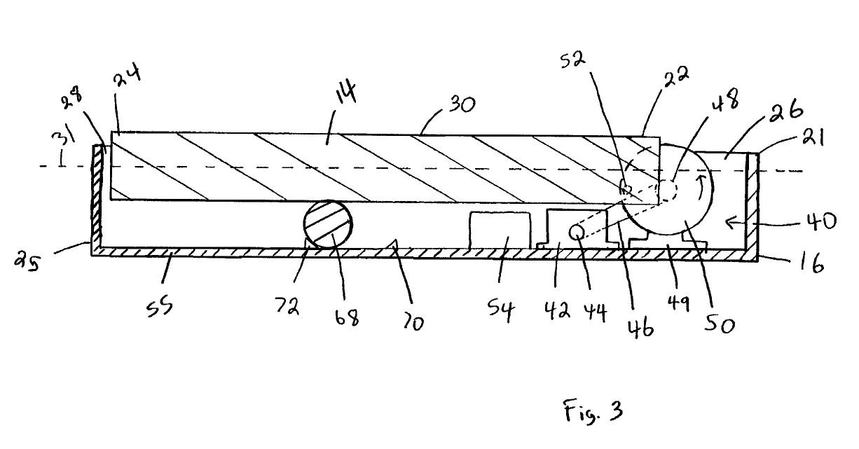

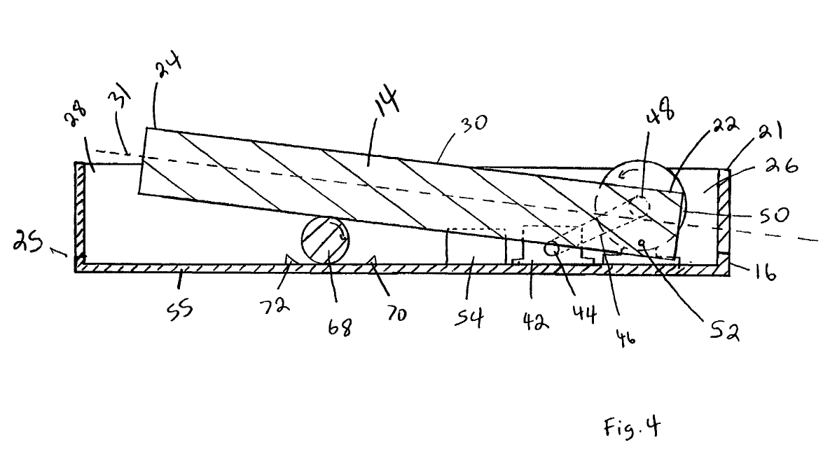

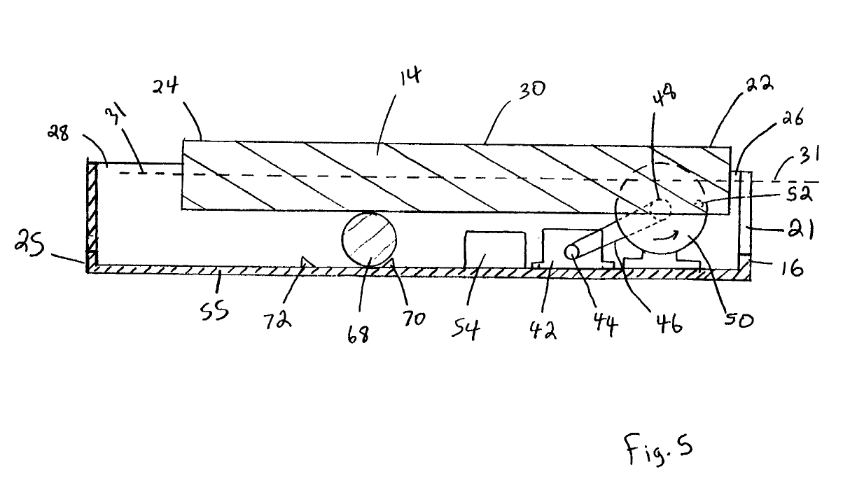

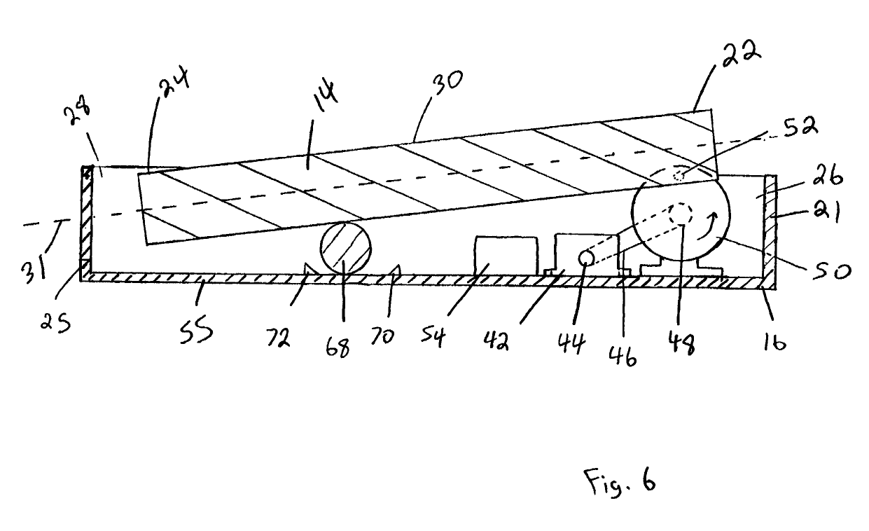

Referring now to FIG. 3, moveable member 14 is pivotally mounted to housing 16 by cylinder 68. Strut 52 is moveably attached to moveable member 14 at a position adjacent to forward edge 22. Strut 52 is in turn rotatably attached to member 50. Member 50 is rotatably attached to mount 49 and is provided with pulley 48. Electric motor 42 drives member 50 via drive belt 46 which couples pulley 44 of the electric motor to pulley 48 of member 50. Electric motor 42 is supplied with electric energy by modulator 54. When modulator 54 is engaged and electric power is provided to motor 42, pulley 44 begins to rotate in a counter clockwise direction thereby causing member 50 to rotate. Rotating member 50 causes moveable member 14 to oscillate in both a back forth direction and in a pivoting direction. In its first position, as seen in FIG. 3, moveable member 14 is position away from front edge 21 of housing 16 and transverse access 31 is substantially at the horizontal. As member 50 rotates, strut 52 moves which in turn forces front edge 22 of moveable member 14 downward and forward as seen in FIG. 4. Since member 14 is moving forward from the first position as shown in FIG. 3 to its second position as shown in FIG. 4, cylinder 68 rotates in a clockwise motion to permit member 14 to move smoothly from its first position into its second position. As member 50 continues to rotate, strut 52 forces forward end 22 of moveable member 14 forward and upward into a third position as shown in FIG. 5. Cylinder 16 continues to rotate in a clock wise direction and moves forward thereby permitting moveable member 14 to move smoothly. Again as member 50 continues to rotate, strut 52 forces end 22 backwards and upwards into a fourth position as shown in FIG. 6. Cylinder 68 then rotates in a counter clockwise direction as member 14 moves from its third position as shown in FIG. 5 to its fourth position as shown in FIG. 6 thereby permitting the moveable member to move smoothly. Finally, as member 50 continues to rotate, strut 52 forces forward portion 22 of moveable member 14 downward and backward back into its first position as shown in FIG. 3.

Top surface 30 of moveable member 14 is adapted to securely retain keyboard 12 without slipping. Therefore, as the wave motion device induces moveable member 14 to move in a back and forth wave like pattern, keyboard 12 is likewise forced to move. As a result, the keyboard user will be forced to move his or her hands not only up and down, but also forward and back. As a result of the back and forth movement of the user's hands, the user has to flex the elbow and shoulder joints, which in turn, results in lubrication of the elbow and shoulder joints. Continuous lubrication of the elbow and shoulder joints decreases the likelihood of injury and strain in the forearms. By combining both motions in the keyboard, the invention reduces the likelihood of injury and strain to the user, since the users joints are being forced through a greater series of motions.

While the apparatus of this invention has been described in terms of preferred embodiments, it will be apparent to those of skill in the art that variations may be applied to the apparatus without departing from the concept, spirit and scope of the invention. All substitutes in modifications apparent to those skilled in the art are deemed to be within the spirit, scope and concept of the invention as defined by the appended claims.

What is claimed is:

1. A keyboard device comprising:
a housing,
a keyboard having forward edge, a back edge and a longitudinal axis, the keyboard being moveably mounted to the housing such that the keyboard is moveable in a first direction whereby the keyboard moves forward and back, and in a second direction whereby the keyboard pivots about the longitudinal axis, and
a moving mechanism for continuously oscillating the keyboard in both the first and second directions simultaneously.

2. A keyboard device as defined in claim 1 wherein the moving mechanism comprises a first member having a forward edge, a back edge and a longitudinal axis, the first member being moveably mounted to the housing such that the first member is moveable in a first direction whereby the first member moves forward and back, and in a second direction whereby the first member pivots about the longitudinal axis, the keyboard being mounted to the first member.

3. A keyboard device as defined in claim 2 wherein the moving mechanism further comprises a second member having a first portion rotatably mounted to the housing and a second portion moveably mounted to the first member, and further comprising an electric motor mechanically coupled to the second member for rotating the second member about its first portion.

4. A keyboard device as defined in claim 3 wherein the second member is pivotally mounted to the first member at a point on the first member between the forward and back edges.

5. A keyboard device as defined in claim 2 wherein the first member has a substantially flat surface configured to receive the keyboard thereon.

6. A keyboard device as defined in claim 2 wherein the housing has a flat bottom surface and wherein the moving mechanism further comprising a cylindrical member positioned on the flat bottom surface of the housing, the cylindrical member having a longitudinal axis, the first member being mounted on top of the cylindrical member such that the long axis of the cylindrical member is parallel to the long axis of the first member, the cylindrical member and flat bottom surface of the housing dimensioned and configured to permit the cylindrical member to roll as the first member moves in the first direction.

7. A device for oscillating a keyboard comprising;
a housing,
a first member having a back edge, a forward edge, a top surface and a longitudinal axis, the member being moveably mounted to the housing such that the first member is moveable in a first direction whereby the first member moves forward and back, and in a second direction whereby the first member pivots about the longitudinal axis, the top surface of the first member adapted and configured to receive a keyboard thereon, and
a moving mechanism for continuously oscillating the first member in both the first and second directions simultaneously.

8. A keyboard device as defined in claim 6 wherein the moving mechanism comprises a second member having a first portion rotatably mounted to the housing and a second portion moveably mounted to the first member, and further comprising an electric motor mechanically coupled to the second member for rotating the second member about its first portion.

9. A keyboard device as defined in claim 7 wherein the second member is pivotally mounted to the first member at a point on the first member between the forward and back edges.

10. A keyboard device as defined in claim 7 wherein the housing has a flat bottom surface and wherein the moving mechanism further comprising a cylindrical member positioned on the flat bottom surface of the housing, the cylindrical member having a longitudinal axis, the first member being mounted on top of the cylindrical member such that the long axis of the cylindrical member is parallel to the long axis of the first member, the cylindrical member and flat bottom surface of the housing dimensioned and configured to permit the cylindrical member to roll as the first member moves in the first direction.
